(19) United States
(12) Patent Application Publication
(10) Pub. No.: US 2013/0235038 A1
(43) Pub. Date: Sep. 12, 2013

(54) Method for Preselecting Three-Dimensional Space for Triggering Automated Construction of a Three-Dimensional Structure

(71) Applicants: Benjamin Michael Tkacheff, San Jose, CA (US); Tyler Randall Mullen, Menlo Park, CA (US)

(72) Inventors: Benjamin Michael Tkacheff, San Jose, CA (US); Tyler Randall Mullen, Menlo Park, CA (US)

(21) Appl. No.: 13/413,023

(22) Filed: Mar. 6, 2012

(51) Int. Cl. G06T 17/00; G06T 15/00

(52) U.S. Cl. 345/424; 345/419

(57) ABSTRACT

A system for constructing a virtual structure in three-dimensional space including an Internet-connected server and software executing on the server from a non-transitory physical medium, the software providing a first function for presenting an interactive builder interface, a second function for enabling selection of a construction unit, a third function for defining parameters of the virtual structure or at least a portion thereof, and a fourth function for automatically rendering the virtual structure or portion thereof according to the defined parameters.

### CROSS-REFERENCE TO RELATED DOCUMENTS

NA

### BACKGROUND OF THE INVENTION

1. Field of the Invention

The present invention is in the field of online gaming and pertains particularly to methods and apparatus for defining a three-dimensional area in a voxel grid system for automated construction a virtual structure using uniform construction units.

2. Discussion of the State of the Art

The voxel grid system is a method of representing three-dimensional (3D) space in a way that can be scaled down to a voxel unit, which represents a pixel unit (two dimensional) with volume (third dimension). Voxel grids are traditionally used to represent three-dimensional views in medical imaging such as in computed tomography (CT) or in magnetic resource imaging (MRI). More recently, voxel representation has been used for 3D gaming systems, in a large part to eliminate or reduce the need for 3D acceleration.

Creating a three dimensional space using a two-dimensional computing interface can be tedious and confusing. In the current art practice of building 3D structures the block or unit of construction for the type of structure defines the 3D space. Therefore, a user constructs the structure one construction unit at a time manually, using a computing input device. Expediency with respect to generating 3D structures, including terrain is desirable in the art of 3D game construction.

Therefore, what is clearly needed is system for constructing a virtual structure in three-dimensional space that solves the problems raised above by allowing the builder to predefine the 3D space and cause automatic filling of the space with the appropriate construction units.

### SUMMARY OF THE INVENTION

The problem stated above is that expediency and resource conservation are desirable for three-dimensional (3D) modeling of virtual terrain and structures, but many of the conventional means for building 3D structures including terrain and architecture, such as real-time serial selection of and placement of construction units, also takes time. The inventors therefore considered functional components of a 3D gaming system, looking for elements that exhibit interoperability that could potentially be harnessed to provide a faster 3D building method, but in a manner that would not create more user task requirement.

Most virtual environments are characterized by the installation many individual 3D building components that are governed by physics simulation. One by-product of this is an inherent complexity and tediousness in the process of creating virtual terrain and structure using two-dimensional (2D) components. Many game editing systems employ software executing from servers and storage systems to provide access to 3D construction units and other game components stored for the purpose of being used to create virtual environments, and software, servers, and storage systems are typically a part of such apparatus.

The present inventor realized in an inventive moment that if, during the process of building a virtual structure, 3D space for containing the structure could be pre-selected and automatic filling of the defined space with the appropriate 3D construction units could be triggered, much time required to build the virtual structure might be eliminated. The inventor therefore constructed a unique system for constructing a virtual structure in three-dimensional space that allowed builders to pre-select 3D space for containing a structure built from construction units and to cause automatic filling of the structure, unit by unit, into the predefined space via a fast part-stamping algorithm. A significant reduction in the time required constructing virtual structure results, with no impediment to task performance created.

Accordingly, in an embodiment of the present invention, a system for constructing a virtual structure in three-dimensional space is provided, comprising an Internet-connected server, and software executing on the server from a non-transitory physical medium, the software providing a first function for presenting an interactive builder interface, a second function for enabling selection of a construction unit, a third function for predefining the three-dimensional space that the virtual structure will fill, and a fourth function for automatically copying and pasting each construction unit into the space reserved for the virtual structure.

In one embodiment, the builder interface is browser-based or nested. In one embodiment the construction unit is a corner wedge, a vertical wedge, or an inverted wedge. In one embodiment, the construction unit is a block or a half-block. In one embodiment, the builder interface is a toolbar. In a preferred embodiment, the construction units and virtual structure are stored on a voxel grid system. In one embodiment, the second and third functions are performed using a computing input mechanism. In this embodiment, the computing input mechanism is a computer mouse, touch pad, or a touch screen interface.

According to one aspect of the invention, a method for constructing a virtual structure in three-dimensional space is provided including the steps (a) selecting, through the aid of a software interface, a three-dimensional construction unit stored in a repository for use in constructing the virtual structure, (b) from within the three-dimensional space, predefining a three-dimensional area of sufficient dimension to encompass two or more construction units of the type selected in step (a), and (c) copying and pasting from the repository, each of the number of construction units of the type selected in step (a) serially and at the correct orientation, into the area defined in step (b).

In one aspect of the method, in step (a), the software interface is browser based or nested. In one aspect, in step (a), the construction unit is a corner wedge, a vertical wedge, or an inverted wedge. In another aspect, in step (a), the construction unit is a block or a half-block. In one aspect, in step (a), the software interface is a toolbar. In one aspect, in step (a), the repository is a voxel grid system. In a preferred aspect of the method, steps (a) and (b) are performed using a computing input mechanism. In this aspect, the computing input mechanism is a computer mouse, touch pad, or a touch screen interface.

In one embodiment, the system further includes a fifth function for automatically smoothing any rough features of the virtual structure. In one aspect, the method further includes a step a step (d) for automatically smoothing any rough features of the virtual structure. In one aspect of the method, in step (b), the area defined includes at least one linear direction for pasting the construction units. In another aspect, in step (b), the area defined includes an arcurate, undulating, or circular path for pasting the construction units.

### BRIEF DESCRIPTION OF THE DRAWING FIGURES

FIG. 1 is an architectural overview of a gaming network that supports dynamic parts stamping according to an embodiment of the present invention.

FIG. 2 is a process flow chart illustrating steps for constructing a virtual structure using dynamic parts stamping according to the embodiment of FIG. 1.

FIG. 3 is a block diagram illustrating three-dimensional space pre-selected for dynamic parts stamping in a virtual environment.

FIG. 4 is a process flow chart illustrating steps for reserving three-dimensional space in a virtual environment according to an embodiment of the present invention.

FIG. 5 is a process flow chart illustrating steps for automated construction of a virtual structure based on data received according to an embodiment of the present invention.

### DETAILED DESCRIPTION

The inventors provide a unique system and method for building virtual structures in virtual space that allows the builder to pre-select the three-dimensional region and to trigger automated filling of the selected space with a pre-selected virtual construction unit. The present invention will be described in enabling detail using the following examples, which may describe more than one relevant embodiment falling within the scope of the present invention.

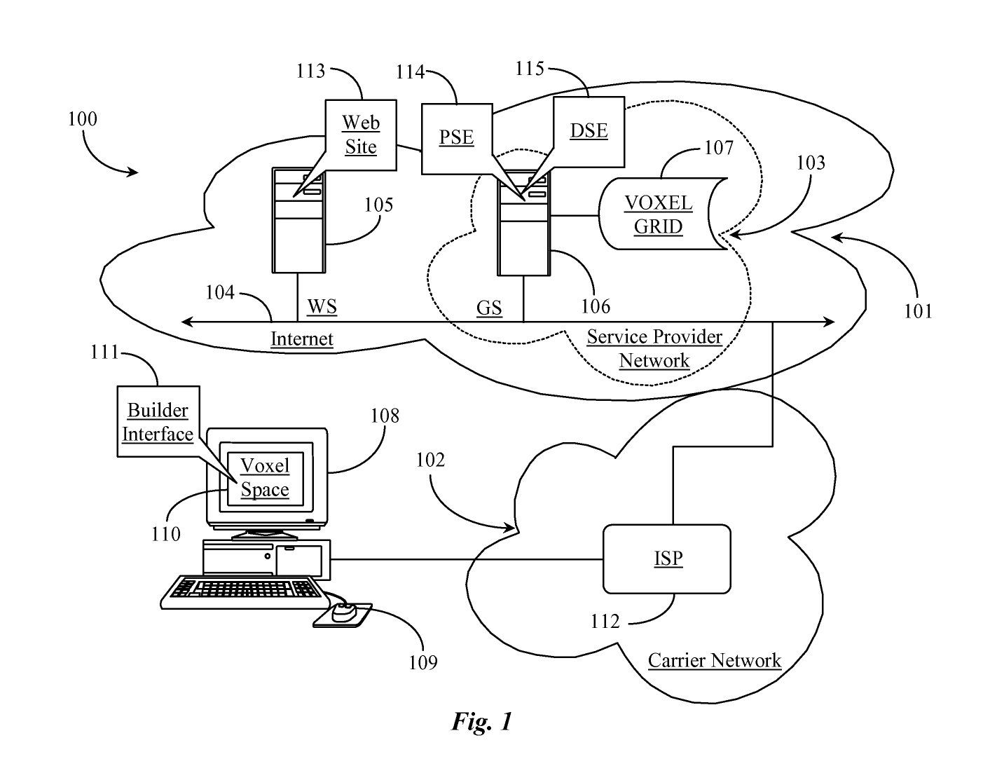

FIG. 1 is an architectural overview of a gaming network 100 that supports dynamic parts stamping according to an embodiment of the present invention. Gaming network 100 includes the Internet network 101, a carrier network 102, and a service provider network 103. Internet network 101 is further represented herein by a network backbone 104. Network backbone 104 includes all of the lines, equipment, and access point that make up the Internet network as a whole. Therefore, there are no geographic limitations to practicing the present invention.

Service provider network 103 represents any provider of gaming services that provides network access to game services to potential clients. Provider network 103 may include a local area network (LAN) or a wide area network (WAN) that has connectivity to Internet backbone 104. Provider network 103 is illustrated within Internet cloud 103 and sharing Internet backbone 104 to represent only that components such as servers and storage repositories within the domain of the service provider may be accessible through the Internet on a 24/7 basis. In actual practice, the service provider network may be connected to Internet 101 through appropriate access lines, routers, and or media gateways.

Internet backbone 104 supports a web server (WS) 105. Web server 105 includes a non-transitory physical medium that contains all of the software and data required to enable function as a web server. WS 105 may be hosted by service provider network 103 or by a third party web-hosting service without departing from the spirit and scope of the present invention. In this example, WS 105 resides outside of service provider network 103. WS 105 hosts a Website 113. Website 113 is a gaming website that provides subscriber access to virtual environments (VE) and games, including game building services provided to subscribing or member clients. In general practice, a potential client registers to play games or to build games or virtual environments through registration services provided on website 113.

Service provider network 103 supports a game server (GS) 106. Game server 106 includes a non-transitory physical medium containing all of the software and data required to enable function as a game server. GS 106 serves online games and virtual environments upon request from authorized clients. GS 106 may also include building services that enable clients to access game development tools for building and editing their own games or virtual environments. In one embodiment, a separate build server is provided for editing and creating virtual environments including games. The inventor illustrates one server and deems the illustration sufficient for describing the server/client relationship and services available through connection to the server.

GS 106 includes a mass repository 107 labeled herein a voxel grid. A voxel is essentially a three-dimensional unit of measure including X, Y, and Z dimensions that define a volume. The voxel grid system is known to and available to the inventor for storing virtual environments including games and game components. Other servers and data repositories may be assumed present in network 103 without departing from the spirit and scope of the present invention like file servers, data servers, and object servers. The inventors illustrate one repository representing a voxel grid system and deem the illustration sufficient for the purpose of explaining the present invention.

A client may access website 113 hosted on WS 105 such as a client operating computing appliance 108, which is a desktop computer in this example. Computer 108 includes a computing input device 109, which is a computer mouse in this example. Other types of computing appliances may be used to access website 113 to register for services without departing from the spirit and scope of the present invention. Examples might include a Laptop computer, notebook, personal digital assistant (PDA), a smart phone, an android device, an iPad™, or any appliance capable of navigating the Internet and submitting data and application control input through an input device like a mouse, trackball, touch screen, touch pad, or the like.

Computing appliance 108 has connectivity to an Internet service provider (ISP) 112 in carrier network 102 via a telephone line, Internet access cable, or via another connection channel such as a wireless channel. Carrier network 102 may be a public switched telephone network (PSTN), a cellular network, a wireless fidelity network (WiFi), or some other sub-network capable of carrying communications, and connected to the Internet. An operator accessing website 113 may register to build virtual environments by joining such as a builder's club to gain access to the required tools and resources for game and VE development.

In one such embodiment, the client operating appliance 108 may access builder's tools such as a builder interface 111 illustrated on appliance 108. In one example, builder interface 111 is accessed from website 113 running on WS 105. In this case, the interface establishes a server connection between the client appliance 108 and game server 106. In another embodiment, builder interface 111 is accessed by the client through gaming server 106 after a server redirection from website 113 to the gaming server. Builder interface 111 may be browser-based or browser nested as a plug in. In one embodiment, builder interface 111 presents as a tool bar or builder studio containing different tools for building and editing games and virtual environments including building virtual structures according to embodiments of the present invention.

Appliance 108 includes a virtual environment display 110 labeled Voxel Space. Voxel space 110 represents the game or other virtual environment being created or edited by the client using builder interface 111. Typically, the display 110 is scalable and navigable with zoom capability. Terrain, buildings, architecture and other structures may be created and edited using interface 111.

Game server 106 includes a physics simulation engine 114 for simulating physics of game play and manipulation of the virtual environment or game resulting from game play. Any construction unit or part represented by virtual objects within the virtual environment may be subject to physics simulation by PSE 114. Game server 106 includes a dynamic stamping engine 115. Dynamic stamping engine 115 represents one or a set of automatic routines or algorithms that are programmed to provide a specific and unique function of dynamic and automatic parts stamping (automated block construction) based on data received relative to predetermined and pre-selected three-dimensional voxel space.

Voxel space 110 is accessible through gaming server 110 as part of the voxel grid stored in repository 107. Voxel space 110 represents a virtual environment or game environment stored on a voxel grid wherein a voxel is the smallest unit of volume on the three-dimensional grid. The voxel space represented in this example is subject to editing by the operator of computing appliance 108 using builder interface 111. One process the operator may engage in during editing is creating a virtual structure using a stock construction unit. A construction unit may be referred to as a virtual part or part in this example. A construction init or part is designed to fit to other parts in specific ways to enable construction of virtual structures, including virtual terrain and terrain features.

Part stamping, a process referred to in this invention, involves repeated placement of a type of part such as a construction block into the space and at the orientation required to construct a virtual structure using, in some cases, many like or identical parts. Such a structure might be a ledge or a wall, a ramp or staircase, an arch or bridge, a tunnel or road, a building or pavilion, or any other type of virtual structure that can be built or assembled with construction units. It is noted herein that a single construction unit such as a wedge, for example, may take up more than one voxel in volume and may in fact encompass many voxels in length, width, and depth representing axis X, axis Y, and axis Z.

In one embodiment, the operator operating computing appliance 108 predefines three-dimensional space within voxel space 110, effectively reserving the space for dynamic part stamping. In this case, dynamic part stamping is an automated process of placing the parts at their correct orientations in the predefined virtual space in such a manner as to cause automated construction of the virtual structure. DSE 115 represents a dynamic stamping engine provided for the purpose of automated structure building based on input data representative of the three-dimensional space reserved for the structure. DSE 115 calculates how many parts and what the correct orientation for those parts will be in the structure based on the data received defining the three-dimensional space reserved for the structure. Once the three-dimensional space is defined, DSE 115 takes the data and provides the part stamping service, which is analogous to an object linking and embedding (OLE) operation such as a serial copy and paste operation.

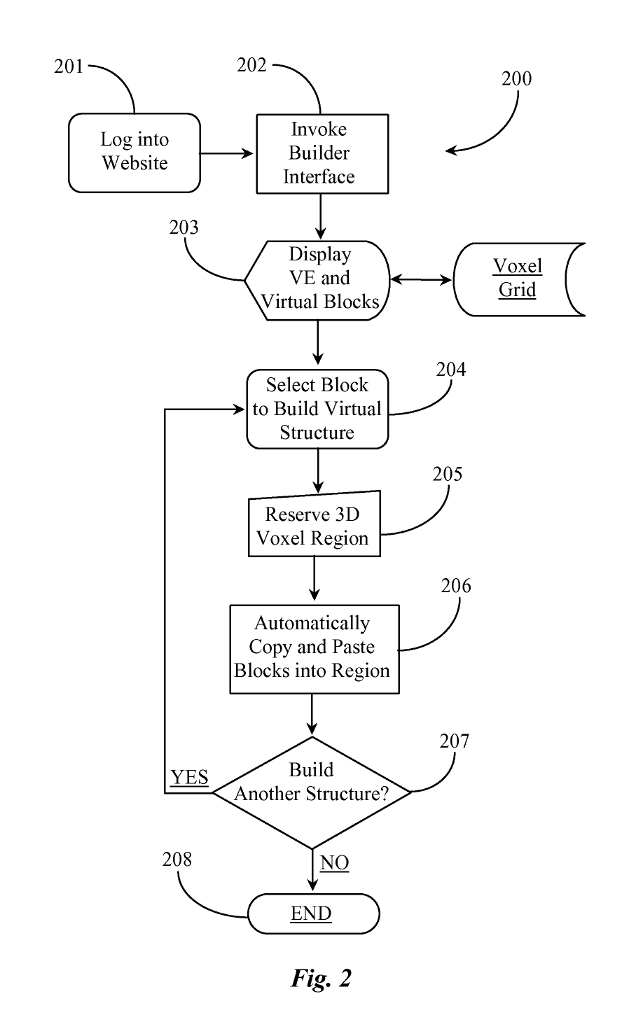

FIG. 2 is a process flow chart 200 illustrating steps for constructing a virtual structure using dynamic parts stamping according to the embodiment of FIG. 1. At step 201, a client logs into a website analogous to website 113 of FIG. 1. It is assumed that the client is registered for and authorized to use build services. At step 202, the operator invokes the builder interface. The builder interface may be personalized to the client and may contain a list of games and or environments the client owns or otherwise has permission to edit. In another aspect, the operator may select a game or virtual environment and then invoke the builder interface. At step 203, the virtual environment (VE) and a visual list of the virtual block types that are available for construction within the environment may be displayed for the client from the voxel grid. The operator may manage more than one VE and may select any one of them for editing.

Virtual blocks are construction units. In one embodiment the construction units include wedge-shapes including corner wedges, vertical wedges, and inverted wedges. Use of wedges in building structures provides a simple and complimentary architecture for connecting and orientating the parts for construction. In other embodiments, other shapes may be envisioned such as rectangular blocks and half-blocks, pie shaped parts, or parts of other polygonal shapes. In one embodiment, the shape of the construction units is restricted to one shape used in a single structure. The shape and shared dimensions of each part enable less computational resource for construction. This allows a simple automated or semi-automated routine to “fill” in the construction parts without relying on physics simulation. Orientation may be determined from analyzing the surrounding terrain. This process (known to the inventor) allows many more parts to be available for generating a terrain model.

At step 204, the operator may select a type block to use in building a virtual structure. Using a same shape block for the entire structure greatly reduces computing resource dependency and enable very fast part stamping. At step 205 the operator reserves a three-dimensional (3D) voxel region. A voxel region may be reserved using a two-dimensional input device like a computer mouse analogous to mouse 109 of FIG. 1. In one aspect, steps 204 and 205 may be reversed in order without departing from the spirit and scope of the present invention. Reserving the voxel region at step 205 is a manual process performed by the operator to define the space that the virtual structure will occupy. Restrictions such as requiring axis establishment to be snapped to the voxel grid or be constrained at, for example a 45 or 90 degree offset of the grid may be applied to make selection of the three-dimensional space easier for the operator and require less computational resource for complete region determination.

At step 206, an automated routine is used such as with a dynamic stamping engine analogous to DSE 115 of FIG. 1 to automatically copy and paste (stamping) blocks into the region and in the correct orientation to result in the effect of automated construction of the virtual structure. Completion of step 206 depends upon the dimensions calculated during the process of step 205. Reservation of voxel space at step 205 is in fact a reservation of defined 3D space that may be communicated to the dynamic stamping engine along with the type of block to use in the construction. Step 205 involves manual selection of space up to, but not more than in three directions more or less constrained to the axes of a three-dimensional grid (X, Y, and Z). More detail about manual selection of voxel space is provided later in this specification.

At step 207, the operator may decide whether or not to build another structure. If the operator decides to build another structure, the process resolves back to step 204 and the process including steps 204, 205, and 206 is repeated to build each new structure. If the operator decides not to build a new structure, the process may end at step 208. An operator may manually edit structures created by automated part stamping based on reserved 3D space. For example, a building construction of a same shape block may be dressed up with other manually selected parts that may be available for use like awnings, windows, doors, and other objects that are not part of the construction units accessible to the dynamic stamping engine. By providing the same shape block or construction unit for basic construction where the block volume is directly proportional to the volume of a voxel unit, the automated routine can calculate the number of parts required and their required orientations in the construction from the data input into the engine by the manual reservation of the 3D space.

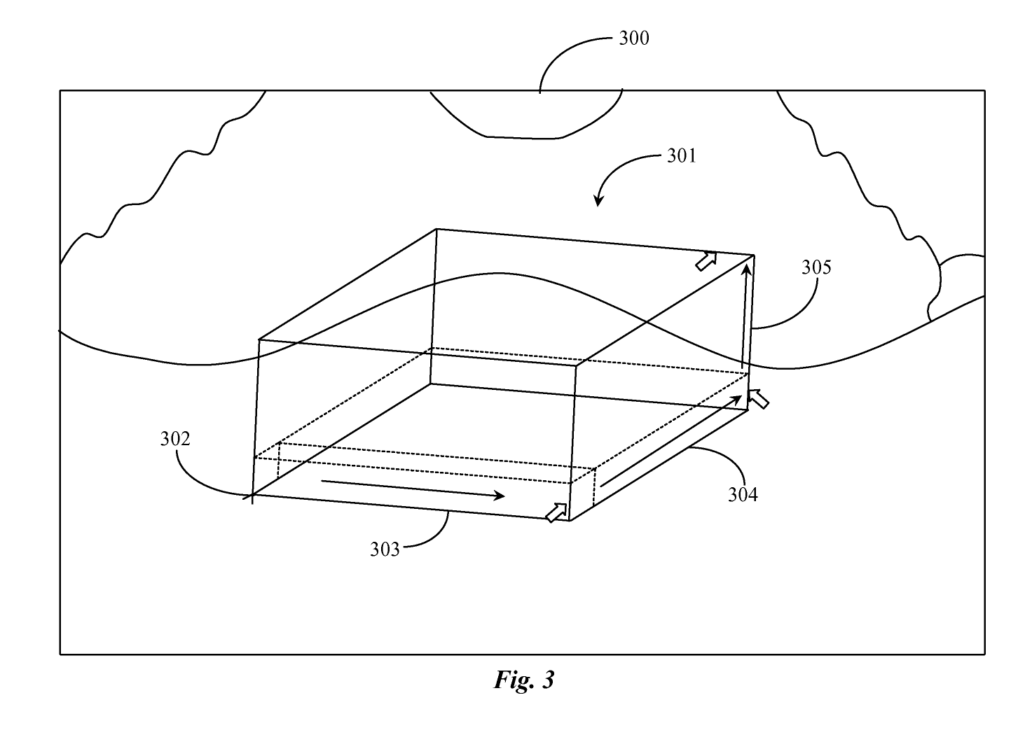

FIG. 3 is a block diagram illustrating three-dimensional space reserved for dynamic parts stamping in a virtual environment 300. Virtual environment 300 is analogous to display 110 of FIG. 1. Existing terrain including mountains are visible in this partial view of a virtual environment. An operator using an avatar or a simple pointer device can navigate through VE 300 including zooming in and out and panning or flying to different parts of the environment.

A voxel region 301 is illustrated in this example residing on the terrain in front of mountains in the background. The region defined is transparent because it has yet to be filled with construction units representing the blocks of the structure created. An operator may, using a simple pointer device like a mouse, begin defining a voxel region by clicking and dragging the mouse from a point on the grid, bottom left in this example, to a desired length along boundary 303 in the direction of the arrow and as evidenced by travel of the “mouse” arrow. The fist selective motion defines a voxel area (broken boundary) that includes the depth and height of the type of construction part selected to build the virtual structure. The operator might stop there only clicking and dragging in a single direction to build, for example, a wall comprised of a number of construction units arrayed linearly in the same orientation fitting to the area defined.

The operator may continue expanding the voxel region along the new direction illustrated by boundary 304 and the directional arrow, and as evidenced by the next position of the mouse arrow. The region is now defined by the larger broken boundary representing three-dimensional space reserved in two directions. The second direction is constrained to be perpendicular to the first direction leaving one direction to expand. The operator may further expand the voxel region by clicking and dragging along boundary 305 in the direction of the arrow and as evidenced by the final position of the mouse arrow. In this case the final voxel region established is a rectangular prism that is aligned to the grid (snapped to grid) or offset from the grid axis by 45 degrees for example. Each direction may be independently selected in order to reserve the three-dimensional space.

In one embodiment, the boundary 305 may be established in the opposite direction instead of the upward direction chosen in this example. Such a selection enables the structure to be built down into the underlying terrain. In a preferred embodiment, options for structure attributes may be provided to the operator for selection and implementation once the voxel space has been completely defined and reserved. For example a fortress that is hollow inside may have a same boundary dimension as a solid abutment of the same three-dimensional footprint. In one aspect, a perimeter of construction units may be established at a desired wall thickness, perhaps one or two units thick where the interior is left hollow. In another aspect, the space may be fully utilized or occupied by construction units orientated in a manner consistent with the structure type and block selection. In another embodiment, a user might begin the process by clicking and moving the mouse pointer or other input device along an arcurate, circular, or sinuous path to establish a structure with like features. Moreover, different polygonal shapes may be available in construction units not limited to pie-shaped wedges, blocks having radial edges, and the like.

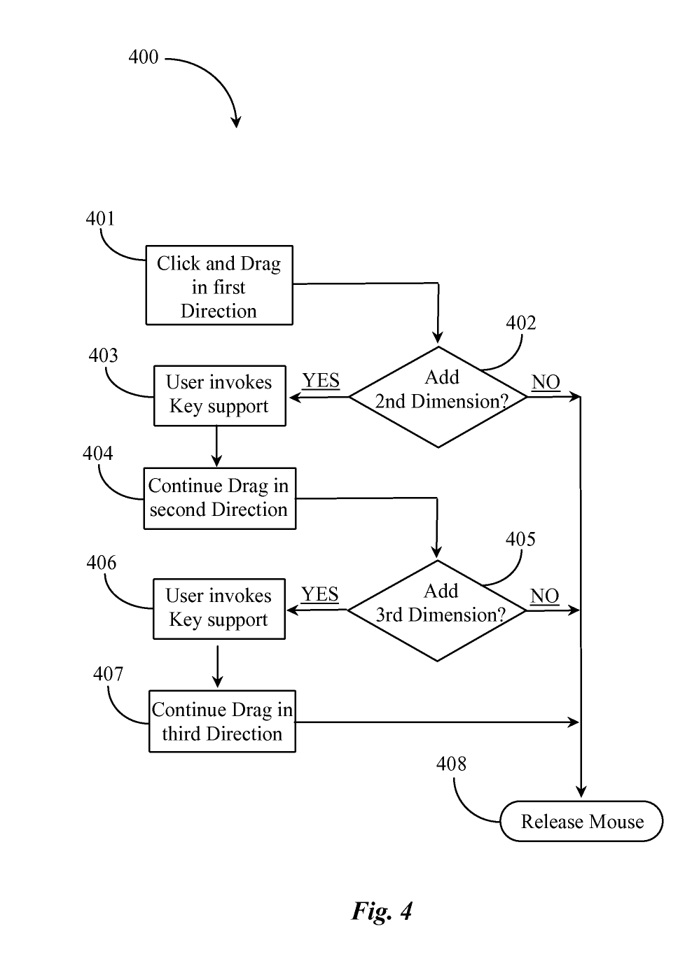

FIG. 4 is a process flow chart 400 illustrating steps for reserving three-dimensional space in a virtual environment according to an embodiment of the present invention. It is assumed in this example, that the user is connected to the gaming server and has his or her virtual space displayed on an appropriate computing appliance such as computing appliance 108 of FIG. 1. One may refer to FIG. 3, voxel region 301 to visualize the three-step process for building a complete voxel region. At step 401, the user clicks and drags the input device in a first direction. An axis is thus defined and that axis is snapped into alignment with the voxel grid, or it may be snapped at some acceptable offset from the grid axis such as at 45 degrees.

At step 402, the user may decide if he or she wants to expand the voxel region by adding a second dimension to the region. If the user does not wish to expand the region by adding a second dimension at step 402, the process may skip to step 408 where the user may release the operation such as by releasing the mouse button, assuming a mouse is the input device. In that case the system would begin copy and paste operation immediately after step 408 to fill the defined voxel region. It is noted herein that other input devices and methods may be used in place of or in addition to a computing mouse without departing from the spirit and scope of the present invention.

If the user desires to expand the voxel region by adding a second dimension at step 402, the user may invoke key support such as by pressing an assigned key on a physical or virtual (touch screen) keyboard or keypad at step 403 and continue dragging in a second direction at step 404. In this example, the second direction is constrained to be perpendicular with the first direction selected. At step 405, the user may decide if he or she wishes to expand the voxel region further by adding a third dimension to the region. If the user decides not to further expand the voxel region at step 405, the process skips to step 408. The resulting region would contain two dimensions.

If the user decides at step 405 to expand the voxel region by adding a third dimension, the user may again invoke key support at step 406 and continue dragging in a third direction at step 407. The third direction is constrained to be perpendicular with the second direction. As such, all directions selected are perpendicular to one another to define a three-dimensional voxel region based on the volume of the selected construction block. An algorithm calculates the amount of blocks that are required to fill the space based on the movements of the input device relative to the voxel grid. The resulting voxel region may include one, two, or three dimensions. In one embodiment, a user may be allowed to scale the activity based on metric of inch measurements equated to each voxel unit, the smallest unit of the grid. Invoking key support may include pressing and releasing an assigned key or pressing and holding an assigned key.

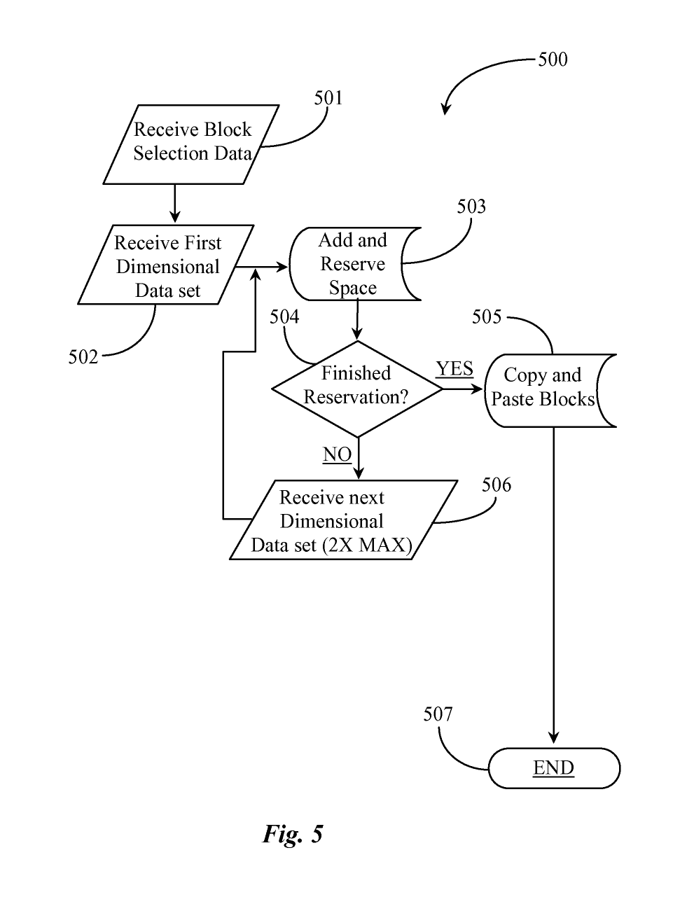

FIG. 5 is a process flow chart 500 illustrating steps for automated construction of a virtual structure based on data received according to an embodiment of the present invention. In this example, it is assumed that the user is logged into the game server and has his or her virtual space displayed for editing. A dynamic stamping engine (DSE) such as engine 115 running on game server 106 accepts user input in the form of selection of the type of block to use in construction of a virtual structure at step 501. In one embodiment, the selection is constrained to a single block shape to reduce the requirement for computational resources required to orientate the blocks and assemble the blocks to form the structure.

The DSE receives a first dimensional data set earmarking the first portion or leg of the complete voxel region at step 502. The first dimensional data set describes a length and direction. The DSE running and algorithm corrects the data according to the existing voxel grid by snapping the axis of the data set to the axis of the voxel grid or by snapping the axis at 45 degrees offset from the grid axis. Other offset angles may be observed without departing from the spirit and scope of the present invention. Additionally, the first data set exhibits a three-dimensional volume equal to the volume of the selected block arranged along the selected direction in an ordered orientation (facing the same way). The system may correct the length selected such that the space will only accept whole blocks.

At step 503, the system adds and reserves the space selected by the first data set. The space is reserved for dynamic parts stamping (copy and paste) performed by algorithm upon request or trigger. At step 504, the system determines if the reservation is complete or finished. This may be determined by a time period elapsing from the end of the click and drag operation, or by an added task of submission of the data.

If the system determines that the user is finished reserving three-dimensional space for the structure at step 504, then the system copies and pastes the correct number of blocks at the correct orientation in step 505, the blocks quickly assembled within the space in the likeness of an automated fill operation. The actual process may mimic a manual build process where each block is orientated and placed into the space serially, but occurs in rapid succession until the space is completely filled with blocks. The user may stop after the first data set is submitted to the system. The effect will be, for example, a single row of blocks much like the first layer of bricks in a vertical wall. However, the user may determine to expand the region by selecting two more directions, each substantially perpendicular to the last, and associated lengths to create a larger region.

At step 505, if the system determines that the user is not finished reserving space, the process moves to step 506 where the system receives a next dimensional data set that expands the region in a substantially perpendicular direction in 3D space from the axis of the last selection. The process then resolves back to step 503 where the system adds and reserves the space. At step 504, the system determines if the user has finished reserving space. If the system determines the user is finished reserving space, the system will copy and paste the blocks at step 505 into the region thus defined by the first and second dimensional data sets. The process will then end at step 507. If the system has determined that the user is not finished reserving space at step 504, the process moves once again to step 506 where the last dimensional data set complimenting a complete three-dimensional voxel region reserved for construction is received. The process again resolves back to step 503 where the system adds and reserves the space fully expanding the region beyond the first and second dimensional data sets.

The limit to the number of directions the user may establish as associated with a volumetric space is three (X, Y, and Z). There may be additional options presented to the user during the process that may clearly define, for example, whether the interior space will be hollow or filled. In one embodiment, only one direction and distance is defined and submitted to establish, for example a row of blocks along that defined boundary from the starting point to the system-determined end point of the distance. The system may round out the distance to ensure that volumetric equivalence exists between the space reserved and a number of blocks to fill the space without overlap of space to block or block to space.

In this example, the system refrains from filling in the selected space until it is established that no more data sets will be submitted. The minimum is one data set and the maximum is three data sets. In one embodiment, the system may perform the copy and paste task (fill space) after each dimensional data set is received. In another embodiment, the system may wait until it is clear that the reservation is complete before filling in the blocks. In one example, a user may submit two dimensional data sets by clicking and dragging the mouse pointer, for example, from a starting point approximately 45 degrees offset from the X axis and then perpendicular to the first direction to create a wide staircase. The width of the staircase is determined by the second directional data set.

In one embodiment, virtual structures can be eliminated in a reverse process of selecting the pre-defined dimensional data set and then deleting the structure, which may trigger a reverse algorithm to serially delete all of the blocks that occupied that space. This function may also be automated so that upon trigger, the structure may appear to disintegrate or loose blocks rapidly as to become unstable leaving dressings such as windows, doors, shelves, and the like to fall as the supporting blocks disappear from the space and no longer support the additional components. In some embodiments the players may control dynamic building and erasing of structures while playing the game to gain advantage over other players in the game. There are many possibilities.

It will be apparent to one with skill in the art that there may be more than one algorithm selected to perform the fill operation according to the dimensional data sets received and other configuration information received such as structure type and block shape selected. Simple walls, ledges and buildings can be semi-automatically constructed as well as more complex structure such as temples, stadiums, and other works that are not necessarily rectangular.

It will also be apparent that the user may apply a time constraint to the automatic fill process after a voxel region has been designed. In such as embodiment, a user may define numerous voxel regions in various levels of a game and then play the game. Each virtual structure to be built may be delayed relative to the copy and paste operation by time constrain or later trigger so that in the environment or game, the structures are built only when it is supposed that those structures may be needed. For example, two players may be in a sword fight when an invisible voxel region known only to one player may suddenly take the form of an intended virtual structure such as a dynamic staircase, which provides an avenue of escape to a next level for the player that pre-defined and saved the region. Certain triggers may also be defined which may trigger dynamic construction of the virtual structures. The other player may also have pre-defined structures that will appear when that player supposes to use them during game play as an escape route or as a block to another player.

It will be apparent to one with skill in the art that the virtual structure building system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for constructing a virtual structure in three-dimensional space, comprising:
an Internet-connected server; and
software executing on the server from a non-transitory physical medium, the software providing:
a first function for presenting an interactive builder interface;
a second function for enabling selection of a construction unit;
a third function for predefining the three-dimensional space that the virtual structure will fill; and
a fourth function for automatically copying and pasting each construction unit into the three-dimensional space reserved for the virtual structure.

2. The system of claim 1, wherein the builder interface is browser-based or nested.

3. The system of claim 1, wherein the construction unit is a corner wedge, a vertical wedge, or an inverted wedge.

4. The system of claim 1, wherein the construction unit is a block or a half-block.

5. The system of claim 2, wherein the builder interface is a toolbar.

6. The system of claim 1, wherein the construction units and virtual structure are stored on a voxel grid system.

7. The system of claim 1, wherein the second and third functions are performed using a computing input mechanism.

8. The system of claim 7, wherein the computing input mechanism is a computer mouse, touch pad, or a touch screen interface.

9. A method for constructing a virtual structure in three-dimensional space comprising the steps:
(a) selecting, through the aid of a software interface, a three-dimensional construction unit stored in a repository for use in constructing the virtual structure;
(b) from within the three-dimensional space, defining a three-dimensional area of sufficient dimension to encompass two or more construction units of the type selected in step (a); and
(c) copying and pasting from the repository, each of the number of construction units of the type selected in step (a) serially and at the correct orientation, into the area defined in step (b).

10. The method of claim 9, wherein in step (a), the software interface is browser based or nested.

11. The method of claim 9, wherein in step (a), the construction unit is a corner wedge, a vertical wedge, or an inverted wedge.

12. The method of claim 9, wherein in step (a), the construction unit is a block or a half-block.

13. The method of claim 10, wherein in step (a), the software interface is a toolbar.

14. The method of claim 9, wherein in step (a), the repository is a voxel grid system.

15. The method of claim 9, wherein steps (a) and (b) are performed using a computing input mechanism.

16. The method of claim 15, wherein the computing input mechanism is a computer mouse, touch pad, or a touch screen interface.

17. The system of claim 1, further including a fifth function for automatically smoothing any rough features of the virtual structure.

18. The method of claim 9, further including a step (d) for automatically smoothing any rough features of the virtual structure.

19. The method of claim 9, wherein in step (b), the area defined includes at least one linear direction for pasting the construction units.

20. The method of claim 9, wherein in step (b), the area defined includes an arcurate, undulating, or circular path for pasting the construction units.
